(19) United States
(12) Patent Application Publication
(10) Pub. No.: US 2014/0078111 A1
(43) Pub. Date: Mar. 20, 2014

(54) TOUCH PANEL

(71) Applicant: SAMSUNG ELECTRO-MECHANICS CO., LTD., Gyunggi-do (KR)

(72) Inventors: Wan Jae Lee, Gyunggi-do (KR); Seung Min Lee, Gyunggi-do (KR); Youn Soo Kim, Gyunggi-do (KR); Ho Joon Park, Gyunggi-do (KR)

(73) Assignee: SAMSUNG ELECTRO-MECHANICS CO., LTD., Gyunggi-do (KR)

(21) Appl. No.: 13/711,429

(22) Filed: Dec. 11, 2012

(30) Foreign Application Priority Data
Sep. 19, 2012 (KR) 10-2012-0104039

(51) Int. Cl. G06F 3/041

(52) U.S. Cl. CPC G06F 3/041
USPC 345/176

(57) ABSTRACT

Disclosed herein is a touch panel. The touch panel 100 according to a preferred embodiment of the present invention is configured to include a transparent substrate 105 that is partitioned into an active region A and a bezel region B disposed at an edge of the active region A, an electrode pattern 110 formed in the active region A, an electrode wiring 120 formed in the bezel region B so as to be connected with the electrode pattern 110, and a display 130 outputting specific light to the bezel region B.

### CROSS REFERENCE TO RELATED APPLICATION

This application claims the benefit of Korean Patent Application No. 10-2012-0104039, filed on Sep. 19, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of a display such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the display.

In addition, the touch panel is classified into a resistive type, a capacitive type, an electro-magnetic type, a surface acoustic wave (SAW) type, and an infrared type. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, the touch panel according to the prior art includes a transparent electrode recognizing touched coordinates and an electrode wiring connected with the transparent electrode, as disclosed in the following Patent Document. In this case, glass disposed at an outermost portion is provided with a printing part so as to prevent the electrode wiring from being recognized from the outside. However, much difficulties and costs are consumed in order to print the printing part. Further, when the glass disposed at an outermost portion and the transparent substrate provided with the transparent electrode are bonded by an adhesive layer, bubbles are generated due to a step of the printing part. Therefore, it is necessary to forcibly increase a pressure of an auto clave so as to remove the bubbles. Further, in order to absorb the step of the printing part, a thickness of the adhesive layer needs to be thick and therefore, transmittance of light may be degraded.

### PRIOR ART DOCUMENT

### Patent Document

(Patent Document 1) US20110298728A1

### SUMMARY OF THE INVENTION

The present invention has been made in an effort to provide a touch panel capable of removing a printing part of a window as maximally as possible by outputting specific light to a bezel region from the display so as to prevent an electrode wiring from being recognized from the outside.

According to a preferred embodiment of the present invention, there is provided a touch panel, including: a transparent substrate partitioned into an active region and a bezel region disposed in an edge of the active region; an electrode pattern formed in the active region; an electrode wiring formed in the bezel region so as to be connected with the electrode pattern; and a display outputting specific light to the bezel region.

Colors of the specific light output by the display may be #000000, #828282, #8c8c8c, #969696, #a0a0a0, #aaaaaa, #b4b4b4, #bebebe, #c8c8c8, #d2d2d2, #dcdcdc, #282828, #323232, #3c3c3c, #464646, #505050, #5a5a5a, #646464, #6e6e6e, #787878, #FFFFFF, #00BFFF, #FFC0CB, or #FF1493 based on a hex triplet value of color name charts.

The display may output the specific light to only the bezel regions disposed at both sides of an edge of a long side of the transparent substrate.

The touch panel may further include: a window disposed in an opposite direction of the display based on the transparent substrate.

The window may be provided with a printing part in regions corresponding to the bezel regions disposed at both sides of a short edge of the transparent substrate.

The transparent substrate and the window may be bonded by a first adhesive layer.

The transparent substrate and the display may be bonded by a second adhesive layer.

The electrode pattern and the electrode wiring may be integrally formed.

The electrode pattern may include: a first electrode pattern formed on one surface of the transparent substrate; and a second electrode pattern formed on the other surface of the transparent substrate.

The electrode wiring may include: a first electrode wiring disposed on one surface of the transparent substrate so as to be connected with the first electrode pattern; and a second electrode wiring disposed on the other surface of the transparent substrate so as to be connected with the second electrode pattern.

The electrode pattern may be formed of copper (Cu), aluminum (Al), gold (Au), silver (Ag), titanium (Ti), palladium (Pd), and chromium (Cr), or a combination thereof.

The electrode pattern may be formed of metal silver formed by exposing/developing a silver salt emulsion layer.

The electrode pattern may be black-oxide treated.

The electrode wiring may be black-oxide treated.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a touch panel according to a preferred embodiment of the present invention;

FIG. 2 is a cross-sectional view of the touch panel taken along the line D-D′ of FIG. 1;

FIG. 3 is a cross-sectional view of the touch panel taken along the line E-E′ of FIG. 1; and

FIGS. 4 and 5 are diagrams illustrating an operating process of the touch panel according to the preferred embodiment of the present invention.

### DESCRIPTION OF THE PREFERRED EMBODIMENTS

The above and other objects, features and advantages of the present invention will be more clearly understood from preferred embodiments and the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

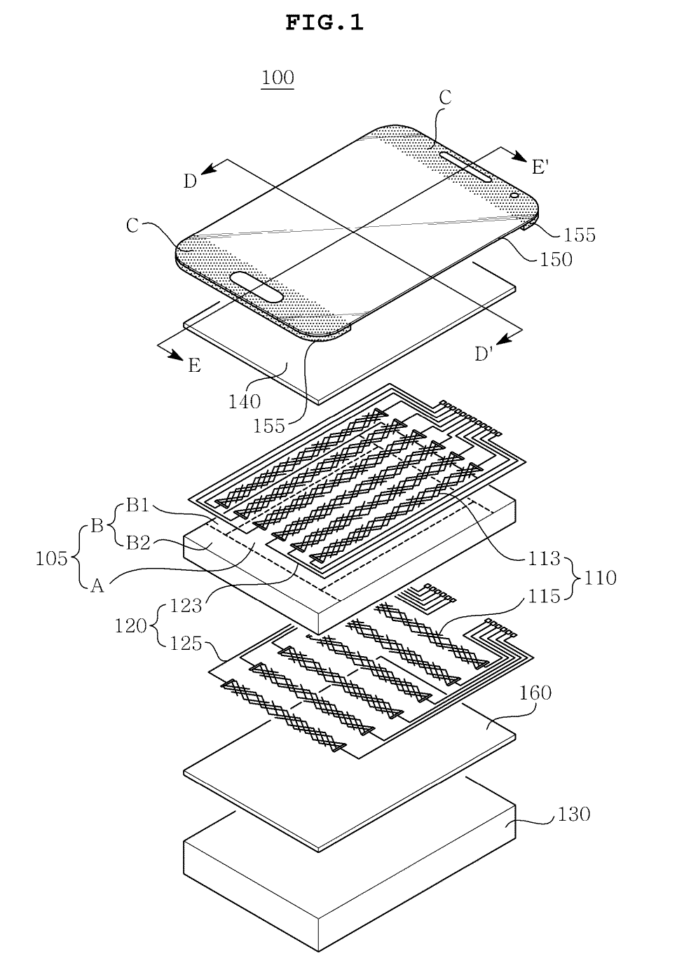

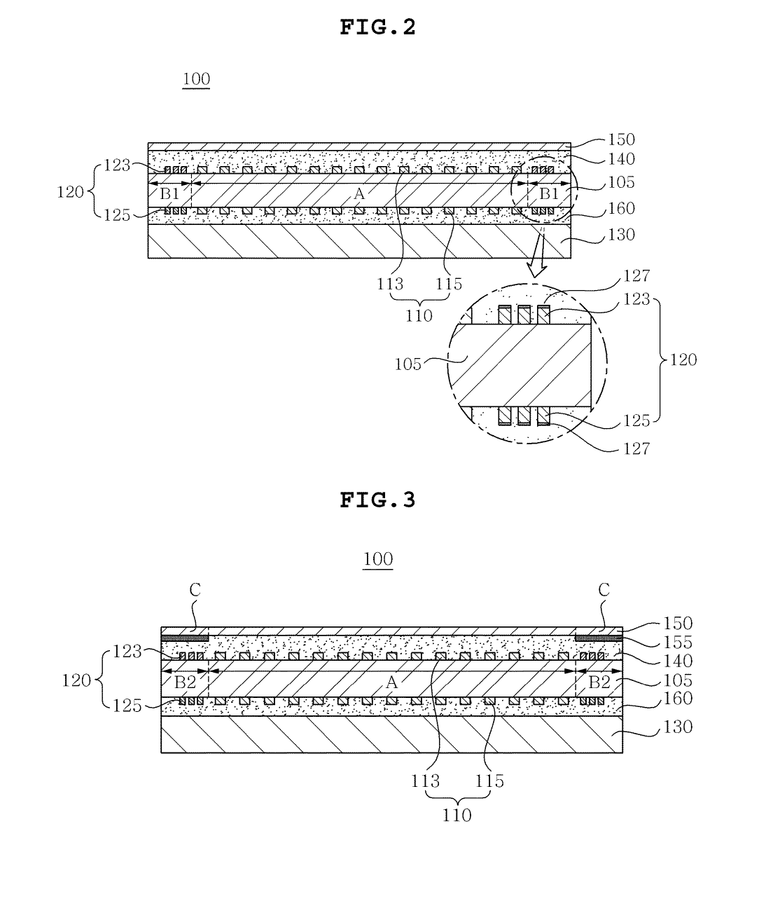

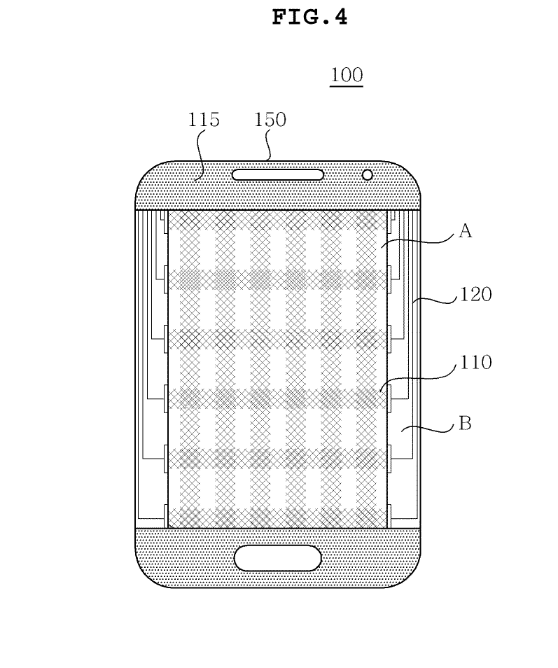

FIG. 1 is an exploded perspective view of a touch panel according to a preferred embodiment of the present invention, FIG. 2 is a cross-sectional view of the touch panel taken along the line D-D′ of FIG. 1, and FIG. 3 is a cross-sectional view of the touch panel taken along the line E-E′ of FIG. 1.

As illustrated in FIGS. 1 to 3, a touch panel 100 according to a preferred embodiment of the present invention is configured to include a transparent substrate 105 that is partitioned into an active region A and a bezel region B disposed at an edge of the active region A, an electrode pattern 110 formed in the active region A, an electrode wiring 120 formed in the bezel region B so as to be connected with the electrode pattern 110, and a display 130 outputting specific light to the bezel region B.

The transparent substrate 105 serves to provide a region in which the electrode pattern 110 and the electrode wiring 120 are formed. In this configuration, the transparent substrate 105 is partitioned into the active region A and the bezel region B, wherein the active region A is a portion in which the electrode pattern 110 is formed so as to recognize a touch of an input unit and is disposed at a center of the transparent substrate 105 and the bezel region B is a portion in which the electrode wiring 120 conducting with the electrode pattern 110 is formed and is disposed at an edge of the active region A. Here, the transparent substrate 105 needs to have a support force capable of supporting the electrode pattern 110 and the electrode wiring 120 and transparency to allow a user to recognize images provided from the display 130. In consideration of the support force and the transparency described above, the transparent substrate 105 may be made of polyethylene terephthalate (PET), polycarbonate (PC), poly methyl methacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but are not necessarily limited thereto.

Meanwhile, a high frequency treatment and a primer treatment may be performed so as to activate a surface of the transparent substrate 105. As such, an adhesion between the transparent substrate 105 and the electrode pattern 110 can be improved by activating the surface of the transparent substrate 105.

The electrode pattern 110 serves to generate a signal when being touched by a user to allow a controller to recognize touched coordinates. Here, the electrode pattern 110 is formed in the active region A of the transparent substrate 105. In addition, the electrode patterns 110 may be formed in a mesh pattern using copper (Cu), aluminum (Al), gold (Au), silver (Ag), titanium (Ti), palladium (Pd), and chromium (Cr), or a combination thereof. In this case, the electrode pattern 110 may be formed by a plating process or a deposition process using sputter. Meanwhile, when the electrode pattern 110 is formed of metals such as copper (Cu), and the like, the surface of the electrode pattern 110 may be black-oxide treated. Here, the black-oxide treating elutes Cu₂O, CuO, and the like, by oxidizing the surface of the electrode pattern 110, wherein the Cu₂O is referred to as blown oxide and the CuO is referred to as black oxide. As such, it is possible to prevent light from being reflected by black-oxide treating the surface of the electrode pattern 110, thereby improving the visibility of the touch panel 100.

Meanwhile, in addition to the foregoing metals, the electrode pattern 110 may also be formed of metal silver formed by exposing/developing a silver salt emulsion layer, metal oxide such as indium thin oxide (ITO), and the like, or conductive polymer such as PEDOT/PSS, and the like, having excellent flexibility and simple coating process. Alternatively, the electrode pattern 110 may be formed of indium tin oxide (ITO), PEDOT/PSS, carbon nanotube (CNT), graphene, zinc oxide (ZnO), Al-doped zinc oxide (AZO), and the like.

Further, the electrode pattern 110 is formed in a bar-shaped pattern in the drawing, but is not limited thereto and the electrode pattern 110 may be formed in all the patterns known to those skilled in the art such as a diamond pattern, a squared pattern, a triangular pattern, a circular pattern, and the like. In addition, the electrode pattern 110 may include a first electrode pattern 113 disposed on one surface of the transparent substrate 105 and a second electrode pattern 115 disposed on the other surface of the transparent substrate 105, but is not necessarily limited thereto and therefore, may be configured variously.

The electrode wiring 120 is connected with the electrode pattern 110 to serve to transmit/receive an electrical signal from the electrode pattern 110. Here, the electrode wiring 120 is formed in the bezel region B. In this case, the electrode wiring 120 is integrally formed with the electrode pattern 110, thereby simplifying the manufacturing process and shortening the lead time. Further, the electrode pattern 110 is integrally formed with the electrode wiring 120, thereby removing the bonding process between the electrode wiring 120 and the electrode pattern 110 and preventing beforehand the occurrence of a step or the bonding defect between the electrode wiring 120 and the electrode pattern 110.

Further, when the electrode pattern 110 includes the first electrode pattern 113 disposed on one surface of the transparent substrate 105 and the second electrode pattern 115 disposed on the other surface of the transparent substrate 105, the electrode wiring 120 may include a first electrode wiring 123 connected with the first electrode wiring 113 and a second electrode wiring 125 connected with the second electrode pattern 115. In this case, the first electrode wiring 123 is disposed on one surface of the transparent substrate 105 and the second electrode wiring 125 is disposed on the other surface of the transparent substrate 105.

Meanwhile, when the electrode wiring 120 is formed of metals such as copper (Cu), and the like, the surface of the electrode wiring 120 may be black-oxide treated similar to the surface of the electrode pattern 110 to form a black-oxide treated layer 127 (see an enlarged view of FIG. 2). The black-oxide treated layer 127 has relatively darker-based color and therefore, when black light is output from the display 130 to the bezel region (B) in which the electrode wiring 120 is formed, it is possible to more efficiently prevent the electrode wiring 120 from being recognized from the outside and the detailed description thereof will be described below.

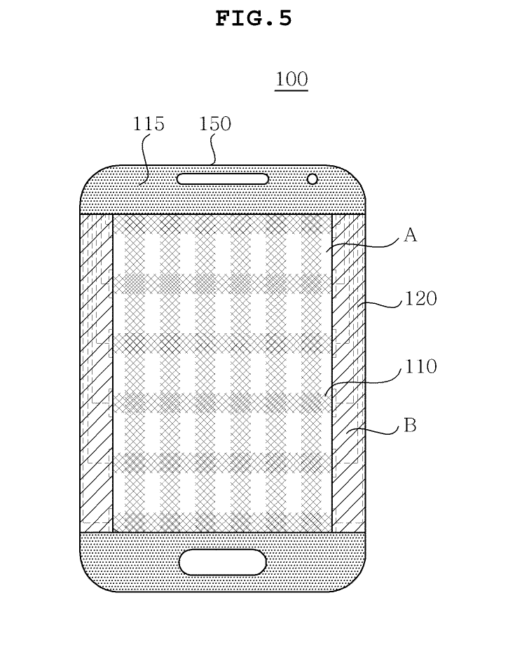

The display 130 serves to output images and includes a liquid crystal display (LCD) device, a plasma display panel (PDP), electroluminescence (EL), a cathode ray tube (CRT), and the like. Here, the display 130 may be bonded to the transparent substrate 105 by a second adhesive layer 160 such as an optical clear adhesive (OCA), and the like. Further, the display 130 outputs a general image to the active region A of the transparent substrate 105 and continues to output only the specific light to the bezel region B of the transparent substrate 105. In this case, the specific light output to the bezel region B from the display 130 serves to prevent the electrode wiring 120 of the bezel region B from being recognized from the outside. FIGS. 4 and 5 are plan views illustrating an operating process of the touch panel according to the preferred embodiment of the present invention. The operating process of the touch panel 100 will be described with reference to FIGS. 4 and 5. First, as illustrated in FIG. 4, the specific light is not output to the bezel region B from the display 130 until the touch panel 110 is operated and therefore, the electrode wiring 120 may be visually recognized. However, the general image is also not output the active region A from the display 130 until the touch panel 100 is operated and therefore, the circumference of the electrode wiring 120 is very dark. As a result, the electrode wiring 120 cannot be not visually recognized. Thereafter, as illustrated in FIG. 5, the specific light is output to the bezel region B from the display 130 after the touch panel 110 is operated and therefore, the electrode wiring 120 is not visually recognized due to the specific light. When the specific light is dark-based colors, the electrode wiring 120 cannot be visually recognized and the color of the specific light may be, for example, black light. In particular, the color of the specific light output from the display 130 is black light and when the electrode wiring 120 is black-oxide treated to form the black-oxide treated layer 127 (see FIG. 2), both of the color of the specific light and the black-oxide treated layer 127 are dark-based color and therefore, it is possible to more effectively prevent the electrode wiring 120 from being recognized from the outside. Here, the black light is #000000 based on a hex triplet value of color name charts. The color of the specific light may be dark-based colors in addition to black light. Describing based on the hex triplet value of the color name charts, the dark-based color may be #828282, #8c8c8c, #969696, #a0a0a0, #aaaaaa, #b4b4b4, #bebebe, #c8c8c8, #d2d2d2, #dcdcdc, #282828, #323232, #3c3c3c, #464646, #505050, #5a5a5a, #646464, #6e6e6e, or #787878.

However, the color of the specific light is not necessarily dark light or dark-based colors and therefore, may be white color, deepskyblue color, pink color, deeppink color, and the like. When the colors are described based on the hex triplet value of the color name charts, the white color is #FFFFFF, the Deepskyblue color is #00BFFF, the pink color is #FFC0CB, and the deeppink color is #FF1493.

As described above, when the specific light is output to the bezel region B from the display 130 to prevent the electrode wiring 120 from being recognized from the outside, a printing part 155 disposed on a window 150 may be completely removed or at least a part thereof may be removed so as to cover the electrode wiring 120 in the prior art. Therefore, the touch panel 100 according to the preferred embodiment of the present invention can save costs for disposing the printing part 155 on the window 150.

Meanwhile, as illustrated in FIGS. 1 to 3, the window 150 may be provided in an opposite direction of the display 130 based on the transparent substrate 105. Here, the window 150 is disposed at the outermost portion of the touch panel 100 to serve to receive the touch of the input unit. In addition, the window 150 may be formed of glass, tempered glass, and the like, but is not necessarily limited thereto. Meanwhile, when the specific light is output to the bezel region B from the display 130 to prevent the electrode wiring 120 from being recognized from the outside, the printing part 155 disposed on the window 150 may be removed so as to cover the electrode wiring 120. However, as illustrated, in order to display a logo, and the like, or secure the region in which operating buttons, and the like, are provided, regions C corresponding to bezel regions B2 disposed at both sides of a short edge of the transparent substrate 105 may be provided with the printing parts 155. That is, top and bottom edges of the window 150 may be provided with the printing parts 155 and left and right edges of the window 150 may not be provided with the printing parts 155 (see FIG. 1). As such, when the regions C corresponding to the bezel regions B2 disposed at both sides of a short edge of the transparent substrate 105 are provided with the printing parts 155, the electrode wiring 120 disposed in the bezel regions B2 disposed at both sides of a short edge of the transparent substrate 105 is covered by the printing part 155 (see FIG. 3). Therefore, the display 130 may output the specific light to only the bezel regions B1 disposed at both sides of an edge of a long side of the transparent substrate 105 (see FIG. 2). However, the case in which the printing parts 155 are formed in the regions C corresponding to the bezel regions B2 disposed at both sides of a short edge of the transparent substrate 105 is only an example and therefore, the printing parts 155 are completely removed if necessary or may be formed anywhere. Meanwhile, the printing part 155 may be formed by printing, for example, colored ink by screen printing, and the like, but is not limited thereto.

Further, the window 150 may be bonded to the transparent substrate 105 by the first adhesive layer 140 such as the optical clear adhesive (OCA), and the like. The touch panel 100 according to the preferred embodiment of the present invention may remove the printing parts 155 to be disposed on the window 150 as maximally as possible by outputting the specific light to the bezel region B from the display 130 as described above. Therefore, when the window 150 is bonded to the transparent substrate 105 by the first adhesive layer 140, the generation of bubbles can be minimized due to the step of the printing part 155, such that it is not necessary to forcibly increase the pressure of the auto clave so as to remove the bubbles. For example, the existing touch panel needs to remove the bubbles from the auto clave for 30 minutes or more, but the touch panel 100 according to the preferred embodiment of the present invention is enough to remove the bubbles from the auto clave for 10 minutes. Further, the touch panel 100 according to the preferred embodiment of the present invention removes the printing part 155 of the window 150 as maximally as possible to absorb the step of the printing part 155 by the first adhesive layer 140 having a relatively thin thickness when the window 150 is bonded to the transparent substrate 105, thereby increasing the transmittance of light.

According to the preferred embodiment of the present invention, it is possible to remove the printing part of the window as maximally as possible by outputting the specific light to the bezel region from the display so as to prevent the electrode wiring from being recognized from the outside, thereby saving the costs for forming the printing part.

Further, according to the preferred embodiment of the present invention, it is possible to minimize the generation of bubbles due to the step of the printing part when the window disposed at the outermost portion and the transparent substrate are bonded by removing the printing part of the window as maximally as possible, thereby preventing the pressure of the auto clave from forcibly increasing so as to remove the bubbles.

In addition, according to the preferred embodiment of the present invention, it is possible to remove the printing part of the window as maximally as possible to absorb the step of the printing part using the adhesive layer having a relatively thin thickness when the window disposed at the outermost portion and the transparent substrate are bonded, thereby increasing the transmittance of light accordingly.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate partitioned into an active region and a bezel region disposed in an edge of the active region;
an electrode pattern formed in the active region;
an electrode wiring formed in the bezel region so as to be connected with the electrode pattern; and
a display outputting specific light to the bezel region.

2. The touch panel as set forth in claim 1, wherein colors of the specific light output by the display are #000000, #828282, #8c8c8c, #969696, #a0a0a0, #aaaaaa, #b4b4b4, #bebebe, #c8c8c8, #d2d2d2, #dcdcdc, #282828, #323232, #3c3c3c, #464646, #505050, #5a5a5a, #646464, #6e6e6e, #787878, #FFFFFF, #00BFFF, #FFC0CB, or #FF1493 based on a hex triplet value of color name charts.

3. The touch panel as set forth in claim 1, wherein the display outputs the specific light to only the bezel regions disposed at both sides of an edge of a long side of the transparent substrate.

4. The touch panel as set forth in claim 1, further comprising:
a window disposed in an opposite direction of the display based on the transparent substrate.

5. The touch panel as set forth in claim 4, wherein the window is provided with a printing part in regions corresponding to the bezel regions disposed at both sides of a short edge of the transparent substrate.

6. The touch panel as set forth in claim 4, wherein the transparent substrate and the window are bonded by a first adhesive layer.

7. The touch panel as set forth in claim 1, wherein the transparent substrate and the display are bonded by a second adhesive layer.

8. The touch panel as set forth in claim 1, wherein the electrode pattern and the electrode wiring are integrally formed.

9. The touch panel as set forth in claim 1, wherein the electrode pattern includes:
a first electrode pattern formed on one surface of the transparent substrate; and
a second electrode pattern formed on the other surface of the transparent substrate.

10. The touch panel as set forth in claim 9, wherein the electrode wiring includes:
a first electrode wiring disposed on one surface of the transparent substrate so as to be connected with the first electrode pattern; and
a second electrode wiring disposed on the other surface of the transparent substrate so as to be connected with the second electrode pattern; and

11. The touch panel as set forth in claim 1, wherein the electrode pattern is formed of copper (Cu), aluminum (Al), gold (Au), silver (Ag), titanium (Ti), palladium (Pd), and chromium (Cr), or a combination thereof.

12. The touch panel as set forth in claim 1, wherein the electrode pattern is formed of metal silver formed by exposing/developing a silver salt emulsion layer.

13. The touch panel as set forth in claim 1, wherein the electrode pattern is black-oxide treated.

14. The touch panel as set forth in claim 1, wherein the electrode wiring is black-oxide treated.
